(19) United States
(12) Patent Application Publication
(10) Pub. No.: US 2026/0105574 A1
(43) Pub. Date: Apr. 16, 2026

(54) IMAGE PROCESSING

(71) Applicant: Hewlett-Packard Development Company, L.P., Spring, TX (US)

(72) Inventors: Fred Charles Thomas, III, Fort Collins, CO (US); Santiago Garcia-Reyero Vinas, San Diego, CA (US); Joshua Alan St. John, San Diego, CA (US)

(73) Assignee: Hewlett-Packard Development Company, L.P., Spring, TX (US)

(21) Appl. No.: 18/913,567

(22) Filed: Oct. 11, 2024

(51) Int. Cl. G06T 5/50; G06T 3/4015; G06V 10/60

(52) U.S. Cl. CPC G06T 5/50; G06T 3/4015; G06V 10/60; G06T 2207/10012; G06T 2207/20208; G06T 2207/20221

(57) ABSTRACT

In an example, a photometric imaging system may include an imaging device to capture a plurality of images under a plurality of different illumination settings. The photometric imaging system can include a graphics unit and a connection bridge. The graphics unit may execute image processing tasks on the plurality of images to obtain processed images defining material channel data. The connection bridge of the photometric imaging system may transmit the plurality of processed images to a secondary electronic device.

### BACKGROUND

Photometric imaging devices facilitate the acquisition of surface and/or material information, which can be used in subsequent processes (e.g., rendering processes). The capture of photometric images includes a number of material channels that define specific properties or aspects of a material, and each material channel may correspond to an attribute that indicates how a material interacts with light and other elements.

### SUMMARY

The systems, methods, and devices of this disclosure each have several innovative aspects, no single one of which is solely responsible for all of the desirable attributes disclosed herein. Details of one or more implementations of the subject matter described in this specification are set forth in the accompanying drawings and descriptions below.

In some aspects, the techniques described herein relate to a photometric stereo image processing system comprising: an imaging device to capture a plurality of images under a plurality of different illumination settings; a transitory storage device to store the plurality of images from the imaging device; a graphics unit to: execute an image processing task on the plurality of images to obtain a plurality of processed images defining material channel data, wherein the execution of the image processing task is based on a characteristic of the images); and a connection bridge to transmit the plurality of processed images to a secondary electronic device.

In some aspects, the techniques described herein relate to an imaging apparatus comprising: an imaging device to capture a plurality of images under a plurality of illumination settings; an embedded graphics unit, comprising: a random access memory (RAM) to store the plurality of images from the imaging device; a graphics unit to execute an image processing task on the plurality of images to obtain a plurality of processed images defining material channel data, wherein execution of the image processing task comprises: determining,, within a subset of the plurality of processed images, a characteristic of each image of the subset of the plurality of processed images, and combining, based on the determined characteristic of each image, the images of the subset into a single processed image to obtain a sampled set of processed images; and a connection bridge to transmit the sampled set of processed images to a secondary electronic device.

In some aspects, the techniques described herein relate to a method, comprising: capturing, using an imaging device, a plurality of images under a plurality of illumination settings; storing the plurality of images in a transitory storage device; executing an image processing task on the plurality of images to obtain a plurality of processed images defining material channel data, wherein executing the image processing task comprises: determining a characteristic of each image of the plurality of images, and combining subsets of the plurality of images to obtain a sampled set of processed images based on the determined characteristics; and transmitting, using a connection bridge, the sampled set of processed images to a secondary electronic device.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1A illustrates a partial schematic top view of a photometric imaging apparatus with three lamps and an imaging device in accordance with some examples of the present disclosure.

FIG. 1B illustrates a schematic perspective view of a lamp oriented at an angle relative to a target area in accordance with some examples of the present disclosure.

FIGS. 2A-2C illustrate a schematic perspective view of an imaging apparatus in accordance with some examples of the present disclosure.

FIG. 3 illustrates a block diagram of at least some of the components of the photometric imaging apparatus in accordance with some examples of the present disclosure.

FIG. 4 illustrates an example data flow for pre-processing of photometric images by the controller of the photometric imaging apparatus in accordance with some examples of the present disclosure.

FIG. 5 illustrates an example routine for local pre-processing of photometric images for transfer to a secondary electronic device.

### DETAILED DESCRIPTION

Physically based rendering (“PBR”) is a graphics technique that seeks to virtualize the appearance of a material surface in a way that models the light and surfaces with optics in the real world. To provide an accurate representation of how light interacts with material properties, PBR-based systems may utilize photometric imaging devices to image real-world samples. For example, a photometric imaging device, such as a photometric stereo imaging device, may include a light source for illuminating a sample and an imaging device (e.g., a camera) to acquire or capture images of the illuminated sample under different lighting conditions (e.g., from two different relative locations with respect to the sample). The illuminated sample may reflect the light, and the reflected light can be used to extract certain information pertaining to the reflective properties of the sample material, referred to as “material channels,” including the directionality and the nature (e.g., diffuse, specular) of the reflections. This reflectance information can be post-processed to obtain the digital three-dimensional (3D) surface topography and/or the 3D surface light reflectance characteristics of the sample. In some examples, the image operation and the image rendering operation may be conducted by different devices.

Typically, image rendering apparatuses may capture and transmit a plurality of images from the photometric imaging device (e.g., camera) to an internal microprocessor via a connection bridge, such as a USB interface. From there, the images may be transferred to an image buffer and eventually to a removable memory device (e.g., SSD card). After transmitting all the image data to the removable memory device, the removable memory device may be physically removed from the image rendering apparatus and inserted into a secondary electronic device (e.g., workstation, desktop PC, notebook, local/remote server), at which further image processing may occur. The main limitation from this process is that the connection bridge (e.g., USB interface) may be limited in file transfer rate. The transfer of all image data from the imaging device to the secondary electronic device via the removable memory device may result in significant inefficiencies in computational costs and time taken. In addition, current approaches or potential approaches to photometric image capture and processing may pose challenges based on computing resource consumption. For example, the storing and transfer of the plurality of images, which in certain cases may contain thousands of images, may involve an increased use of computing resources both for the image rendering apparatus and additional secondary electronic devices. Latency issues may also arise from the time needed to capture, store, transfer, and upload photometric images between the image rendering apparatus and the additional secondary electronic devices.

In light of the present disclosure, the embodiments disclosed herein improve the ability of computing systems, such as the image rendering apparatus, to implement local pre-processing of images for transfer to secondary electronic devices. Examples of secondary electronic devices comprise workstations, desktop PCs, notebooks, and local/remote servers. By processing the images locally within the image rendering apparatus, internal and external transfer times may be reduced as the secondary electronic device may receive images that have already been processed. This may allow the downstream conservation of PBR-related computing resources. Additionally, this allows for reducing the computational requirements for the secondary electronic device, thereby awarding the image rendering process with additional flexibility (e.g., secondary electronic devices with lower computational resources may be used).

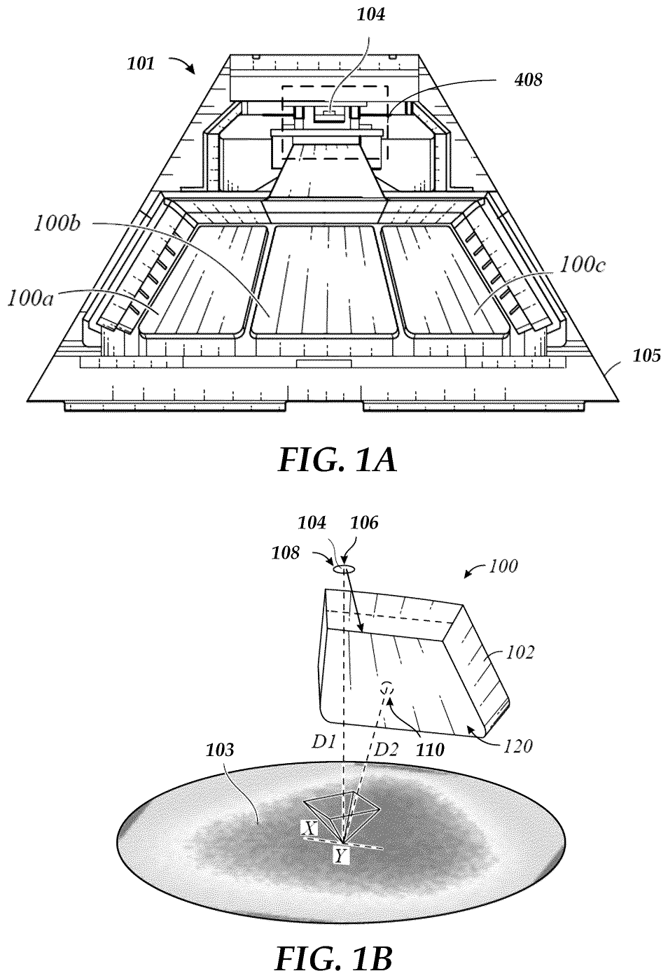

Various examples disclosed herein relate to a near-light light source (e.g., illuminator or near-light illuminator) that can be used in a near-light system or device (e.g., near-light apparatus, or photometric imaging system), or an imaging method. FIGS. 1A-1B illustrate different views of a lamp 100 in a light box 102 (e.g., casing or frame) that can be used in an imaging device (e.g., near-light photometric imaging apparatus or imaging apparatus). In FIG. 1A, a perspective cross-sectional view of a lamp 100 that can be used in a imaging apparatus 101 (e.g., near-light imaging apparatus) or in a near-light device is shown. In some examples, the lamp 100 (e.g., a light emitting diode (LED) light-box panel) can include multiple layers (e.g., first layer, second layer) having multiple functions. The imaging apparatus 101 of FIG. 1A further comprises a graphics unit 408 (shown in FIG. 1A with a dotted box).

In some examples, and as shown in FIG. 1A and FIG. 1B, an imaging apparatus 101 (e.g., near-light imaging apparatus) can include a lamp 100. The lamp 100 may include one or more of the embodiments described in U.S. application Ser. No. 18/785682, which was filed on Jul. 26, 2024 and is hereby incorporated by reference in its entirety for all purposes. In some examples, the imaging apparatus 101 can include at least one lamp which can have the structure of the lamp 100. In FIG. 1A, three lamps (100a, 100b, 100c) are illustrated in a cross-sectional perspective view of the interior of an imaging apparatus 101. The individual lamps can be oriented at an angle relative to a target area 103 as shown in FIG. 1B. For example, a lamp 100 in the imaging apparatus 101 can be positioned to have a grazing angle of approximately 30° with respect to the target area 103. In some cases, the lamp 100 can be positioned to have a grazing angle in a range of approximately 10°-70° with respect to the target area 103. The individual lamp(s) can be fixed on an interior surface of the imaging apparatus 101. In some examples, the imaging apparatus 101 may include a single lamp (e.g., lamp 100) that is a movable lamp that can be moved to different positions relative to the target area 103. In some other examples, the imaging apparatus 101 may include between two and eight lamps, where an individual lamp is in a fixed position relative to the target area 103. In some cases, the imaging apparatus 101 may include less than ten lamps, or less than twelve lamps. Implementing a greater number of lamps (e.g., eight) can help increase the amount of information collected pertaining to the surface of a sample, improving the quality of the imaging data collected. It is noted that some elements in FIG. 1A have been omitted in FIG. 1B.

Lamp 100 may operate according to various light or illumination settings. As described herein, light settings or illumination settings refer to a set of parameters implemented by a light source (e.g., lamp 100) during an image acquisition process, such as a light direction used for illuminating a sample using the light source. Additional parameters, illumination settings, or light settings can include at least one of a brightness level and an orientation of the light to be emitted towards the sample. In addition, illumination settings can also include various combinations of light settings and polarizer view states. In some examples, a single lamp can provide different light settings. In other examples, when having multiple lamps, different light settings may be implemented by each of the lamps. In some examples, during an imaging acquisition process, a light source may illuminate a sample in accordance with a plurality of different illumination settings (e.g., by illuminating a sample by emitting light from different light directions using a light source).

The imaging apparatus 101 can also include an imaging device 104 capable of capturing an image of a sample illuminated by a lamp 100. The imaging device 104 can be a camera. For example, the camera can be a color complementary metal-oxide semiconductor (CMOS) imager. In some examples, the camera can include approximately between 40 MP and 200 MP. In some examples, the camera includes 108 MP. In some examples, the imaging device 104 can include a 7-lens element for high fidelity images over a target area, an optical image stabilizer, and/or focusing capabilities that can include autofocusing capabilities or manual focusing capabilities. In some examples, the imaging device 104 can be a mobile phone camera module. In some cases, the imaging apparatus 101 can include more than one imaging device 104. For example, the imaging apparatus 101 can include two imaging devices 104 (e.g., two cameras) to allow for dual photometric stereo sampling and adding the capability of 3D stereo vision true depth measurement to the system. In some cases, the imaging device 104 may be removable. For example, the imaging apparatus 101 can include an element (e.g., a mount, imaging device holder, etc.) or a receptacle to receive the imaging device 104, which can facilitate placement of the imaging device 104 along an imaging axis 106.

Graphics unit 408 may be a component of the image processing system, specifically a component of the controller 301. In some embodiments, the graphics unit 408 may execute various image processing tasks on the plurality of images captured by the system to obtain a plurality of processed images defining material channel data. The image processing tasks may be executed on the plurality of images based on characteristics of the images captured by the imaging device 104. In some examples, the graphics unit 408 may have embedded computational capacity to execute the various image processing tasks on the plurality of images captured by the system. For example, the graphics unit may, in some embodiments, perform at a peak greater than 5 TFLOPS and greater than 15 TOPS.

As shown in FIG. 1B, the imaging device 104 of the imaging apparatus 101 can be placed parallel to an imaging axis 106 that is perpendicular to the target area 103. In particular, the imaging device 104 can be located at a position 108 relative to the lamps (e.g., lamp 100) and the target area 103. The imaging device 104 can be located a first distance D1 away from the target area 103. D1 can be a distance in a range of approximately 10 cm-1000 cm. A lamp 100 having a center 110 (indicated by the dashed circle in the figure), can be positioned relative to the target area 103, such that the center 110 is a second distance D2 away from an edge of a sample on the target area 103. D2 can be a distance proximate to the edge of the sample being viewed in a range of approximately 0 cm - 100 cm from the edge of the sample. Further, although FIGS. 1A-1B illustrate a lamp 100 having an approximately trapezoidal shape, the lamp 100 can take on other shapes. For example, lamp 100 can be rectangular, triangular, or circular, among other shapes. In some embodiments, the linearly polarized light can be transmitted through an anti-reflective film 120 disposed on the front surface of the lamp.

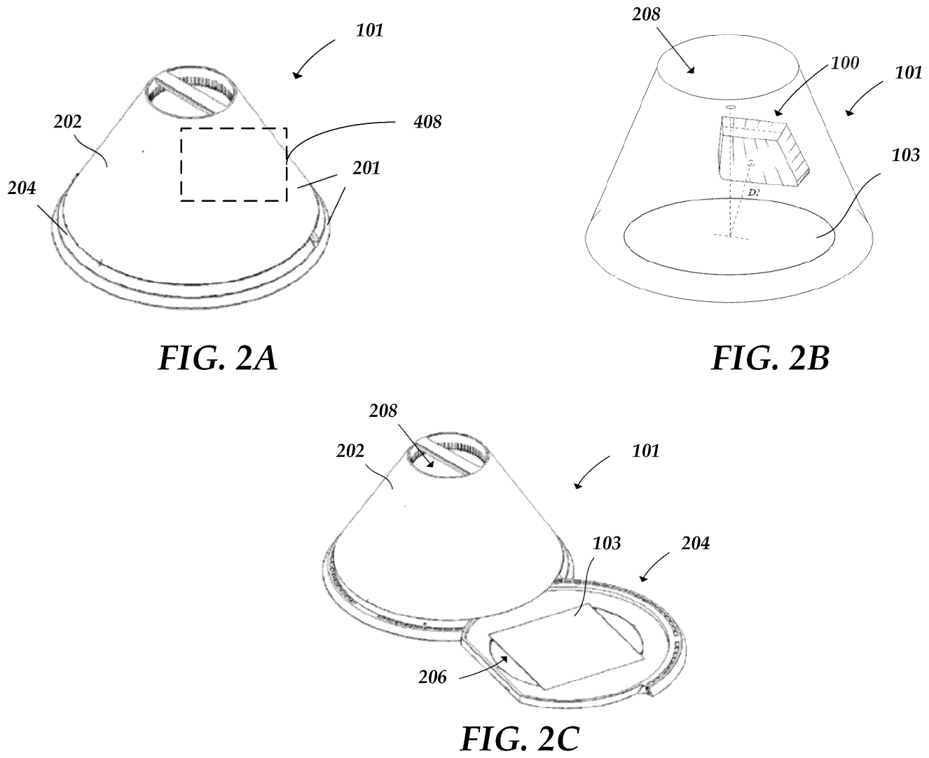

FIG. 2A illustrates a schematic view of the imaging apparatus 101. Some elements have been omitted from the schematic view to simplify the representation. The imaging apparatus 101 can include a housing 201 having two portions (e.g., a first portion 202 and a second portion 204). In some examples, a imaging apparatus 101 includes an imaging device 104. In these examples, the imaging device 104 may be removable relative to the housing 201. In some examples, the imaging device 104 may be a fixed imaging device relative to the housing 201 (e.g., fixed within or on the housing 105. In some cases, where an imaging device 104 is included, the first portion 202 can be an upper portion of the housing 201 including an inner volume 208 in which the lamps 100 and the imaging device 104 can be positioned. In some examples, as shown in FIG. 2B, a lamp 100 can be fixed in position in the inner volume 208 of the first portion 202 of the housing 201, such that the center 110 is a distance D2 away from the target area 103. Although FIG. 2B illustrates an example using a lamp 100. The second portion 204 can be a lower portion of the housing 201 that couples to the first portion 202. The second portion 204 can include the target area 103 located within a sample tray 206 upon which a sample can be placed for imaging. In some cases, the sample tray 206 can be accessed by rotating it outward or away from the first portion 202. Although FIG. 2C shows the second portion 204 in an open configuration in which the second portion 204 remains attached to the first portion 202, in some cases, the second portion 204 can be completely separated and detached from the first portion 202. In some examples, the second portion 204 can be separated from the first portion 202 through a rotating mechanism, such that the second portion 204 can be rotated away from the first portion 202 to make the sample tray 206 accessible to a user. In some cases, the second portion 204 can be displaced with respect to the first portion 202 through a non-rotating or linear sliding mechanism. In some examples, the first portion 202 may comprise an aperture to receive a sample tray 206 that is removable or movable relative to the first portion 202. In some cases, inserting the sample tray 206 of the second portion 204 completely into the aperture may function to block or reduce ambient light (or background light) from entering the near-light apparatus. In some examples, the target area 103 is a removable target area relative to the imaging device 104.

The first portion 202 can include a rigid conical structure to house at least a first lamp (e.g., lamp 100). The rigid conical structure can include an interior surface that is angled, such that when a lamp 100 is positioned on the interior surface, the lamp 100 may be positioned such that light emitted from the lamp will have a low grazing angle (e.g., approximately 30 degrees) relative to the target area 103. In some examples, where the imaging apparatus 101 includes eight lamps, the eight lamps can be arranged in an octagonal configuration that is approximately centered with respect to the imaging device 104. FIG. 2A also illustrates additional components, such as the graphics unit 408 (shown in FIG. 1A with a dotted box). It is noted that some elements in FIG. 2A have been omitted in FIGS. 2B and 2C.

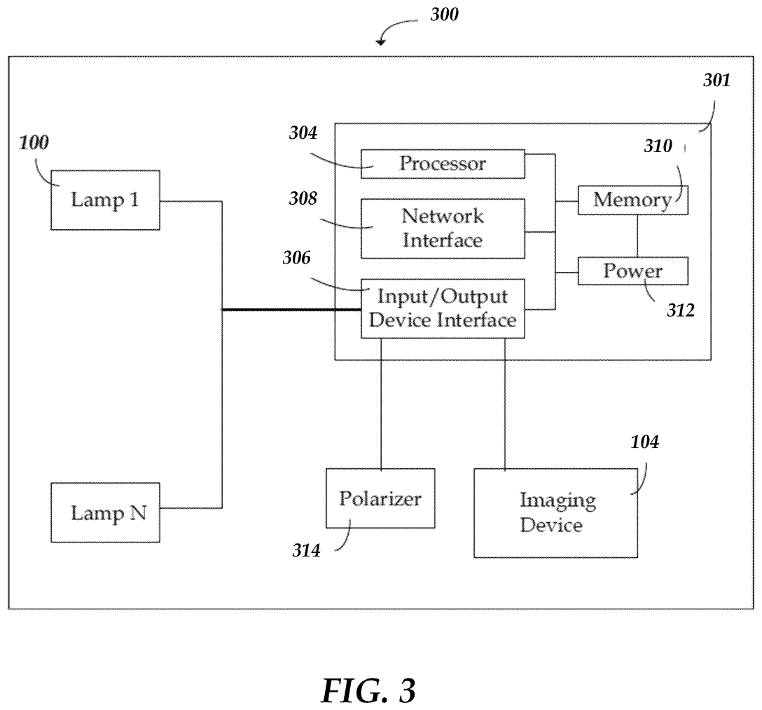

In some examples, a photometric imaging system 300 (see FIG. 3) may correspond to an apparatus including the imaging apparatus 101 The photometric imaging system 300 may include and use the lamps described in relation to FIGS. 1A and 1B (e.g., lamp 100). In some cases, a single lamp (e.g., lamp 100) may be used for illumination, and the single lamp can be moved to different positions relative to a target area 103. In some cases, multiple lamps (e.g., two or more lamps) may be used for illumination, and each of the lamps may be located at a different position relative to the target area 103. In some examples, the photometric imaging system 300 may include an imaging device 104 that is removable. In some other examples, the photometric imaging system 300 may include an imaging device 104 that is fixed.

FIG. 3 illustrates a schematic block diagram depicting an illustrative general architecture of a photometric imaging system 300, which may include a near-light imaging apparatus 101. Photometric imaging system 300 includes lamp 100, controller 301 (control or processing unit), and imaging device 104 (e.g., camera), and polarizer 314. The photometric imaging system 300 can include more (or fewer) components than those shown in FIG. 3. For example, in some embodiments, the photometric imaging system 300 may not include the polarizer 314.

Imaging device 104 may be capable of capturing an image of a sample illuminated by a lamp 100. To capture the material surface of the sample illuminated by the lamp 100, the imaging device 104 may be configured to capture a plurality of images under a plurality of illumination settings. Illumination settings can include any setting relating to the capture of an image illuminated by the lamp 100 or within the photometric imaging system 300. For example, illumination settings can include at least one of a light orientation setting, a brightness level, a polarizer viewing state, and the like. In photometric stereo applications, images are captured when a sample is illuminated from two different directions. Accordingly, the illumination settings might define the light orientation setting, and any additional settings, such as a brightness level, a polarizer viewing state (when a polarizer is available), a color temperature, and the like.

Controller 301 can include a processor 304, which may be an embedded processor or an embedded graphics unit, and an input/output device interface (e.g., I/O device interface 306). In some examples, the I/O device interface 306 can include a user interface (not shown) for operating or controlling the photometric imaging system 300 and/or data analysis. In some examples, the controller 301 can include a network interface 308. In some examples, the network interface 308 can allow for short-range wireless connections (e.g., Bluetooth® or Wi-Fi connection). The controller 301 components can communicate with one another by way of a communication bus. The controller 301 is associated with, or in communication with, at least one output device and at least one input device. For example, the output device can be the lamp 100 (e.g., Lamp 1—Lamp N, where N is greater than 1). In other examples, lamp 100 may correspond to a single lamp capable of providing different illumination settings (e.g., a lamp movable relative to the sample such that the lamp can emit light from different relative directions). The network and/or host computer interface 308 can provide the controller 301 with connectivity to one or more networks or computing systems. The processor 304 can thus receive information and instructions from other processing systems or services via a network (e.g., a wide area network (WAN), a wireless personal area network (WPAN), local area network (LAN), the Internet, etc.). The processor 304 can also communicate to and from the memory 310 and further provide output information (e.g., a plurality of images) for an output device (e.g., a display (not shown)) via the I/O device interface 306. The I/O device interface 306 can accept input from an input device (e.g., imaging data or information acquired from the camera). The memory 310 can contain computer program instructions that can be executed by the processor 304. In some examples, the memory 310 can include RAM, ROM, and/or other persistent or non-transitory computer-readable storage media. The controller 301 further includes a power source for providing power 312 to the controller 301.

In some examples, the controller 301 facilitates the operation of at least one of each of the lamps 100 and the imaging device 104, which can be removable or fixed. For example, the controller 301 can control a brightness of the lamp 100 by adjusting an amount of current to be delivered to each lamp 100 to power the plurality of LEDs in each lamp 100. The controller 301 can additionally facilitate calibrating a lamp 100, in part, by sending signals to adjust a polarizer 314 (e.g., rotate a linear polarizer) along an optical pathway including the imaging device 104 relative to an individual lamp 100 having a linear polarizer film. Although FIG. 3 illustrates an example using a lamp 100, any of the lamps previously described can be used instead. The controller 301 can also function to operate the imaging device 104 such that the imaging device 104 can capture multiple images of the sample as the sample is illuminated from different directions. For example, the controller 301 can instruct the imaging device 104 to capture an image or otherwise acquire image data of a sample. The controller 301 can receive the image data and send the image data to the processor 304, which can facilitate obtaining a plurality of properties of the sample. These properties include properties of the sample's material. For example, these properties may include surface roughness, color, surface normal information, and more. These properties can subsequently be used in physically based rendering (PBR) processes, which can help provide an accurate representation of how light interacts with various materials.

In some examples, the controller 301 can send signals to the imaging device 104 to enable autofocusing of the imaging device 104 relative to the target area 103. In some examples, the controller 301 can facilitate an ordered acquisition (e.g., a user-defined order for acquiring images of a sample illuminated by individual lamps at different positions relative to the sample) by the imaging device 104 to capture a first image of the sample illuminated by a first lamp (e.g., lamp 100) and a second image of the sample illuminated by a second lamp (e.g., lamp 100). In some examples, the controller 301 can instruct the imaging device 104 to capture a first image of a sample with a first light setting and a second image of the sample with a second light setting. The first and second light settings are the light parameters to be implemented for an image acquisition. The first light setting can include at least a brightness and an orientation of the light. In some cases, the first light setting can be provided by the first lamp and the second light setting can be provided by a second lamp. In some cases, the first and the second light settings can be provided by the first lamp. Although multiple lamps are illustrated, a single lamp could be used instead, and the single lamp could provide different light settings where a light setting is associated with a different orientation of the single lamp relative to the sample (e.g., a first light setting corresponds to a first orientation and a second light setting corresponds to a second orientation). In some cases, the controller can facilitate rotating the single lamp relative to the sample and enable the camera to acquire images of the sample as it is illuminated by the single lamp at different positions. In some cases, the controller 301 can facilitate rotating the sample relative to the single lamp and enable the imaging device to acquire images of the sample as it is rotated. In some examples, the polarizer 314 may be disposed between the imaging device 104 and the sample. In some cases, the polarizer 314 may be a linear polarizer in which a polarization viewing state of the linear polarizer can be adjusted by rotating the linear polarizer. In some cases, the polarizer 314 may be an optical filter such as a liquid crystal tunable filter, where the polarization viewing state can be adjusted through varying a drive current provided to the liquid crystal tunable filter.

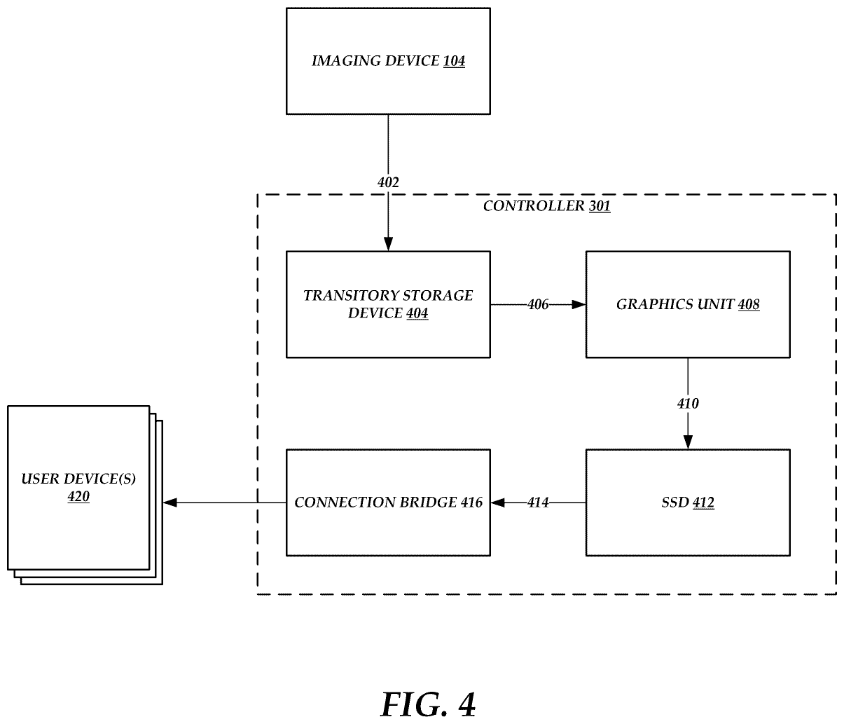

FIG. 4 illustrates an example data flow for pre-processing of photometric images by the controller of the photometric imaging apparatus in accordance with some examples of the present disclosure.

As noted herein, controller 301 can instruct the imaging device 104 to capture images with various light or illumination settings. Illumination settings can include any setting relating to the capture of an image illuminated by the lamp 100 or within the photometric imaging system 300. For example, illumination settings can include at least one of a light orientation setting, a brightness level, a polarizer viewing state, and the like. In photometric stereo applications, images are captured when a sample is illuminated from two different directions. Accordingly, the illumination settings might define the light orientation setting, and any additional settings, such as a brightness level, a polarizer viewing state (when a polarizer is available), a color temperature, and the like. In some embodiments, the imaging device 104 captures an image using illumination settings associated with a photometric capture process (e.g., by sequentially illuminating a sample from different relative locations). Photometric capture processes may include photometric stereo capture or spatially varying bidirectional reflectance distribution (“SVBRDF”) capture.

In some embodiments, controller 301 instructs the imaging device 104 to capture a plurality of images. As described herein, photometric stereo capture systems, such as the photometric imaging system 300, may capture a plurality of images under different lighting conditions (e.g., at least two different lighting orientations) to model a shadow behavior of a material surface. Examples of lighting conditions comprise a direction of the light, a brightness level and an orientation of the light to be emitted towards the sample. In some examples, a single lamp can provide different light settings. In other examples, when having multiple lamps, different light settings may be implemented by each of the lamps, as described above. The plurality of images may be used to derive a plurality of material channels (e.g., shadow placement can be used for estimating factors such as surface normal, roughness, curvature). In some embodiments, the controller 301 instructs the imaging device 104 to capture 2048 total images under a plurality of illumination settings. Images captured by the imaging device 104 may be a uniform size, such as 250Mb.

Upon capture of the plurality of images, the controller 301 may store the plurality of images (e.g., 2048 images) in a transitory storage device 404. Transitory storage device 404 may include any temporary or volatile data store, such as random access memory (RAM), dynamic random access memory (DRAM), and the like. Transitory storage device 404 may be a portion of the memory 310 reserved for storage of the plurality of images captured by the imaging device 104. In some embodiments, the transitory storage device 404 receives the plurality of images from the imaging device 104 via a serial interface 402. Serial interface 402 includes any high-speed interface between a host processor and display module, such as a display serial interface (DSI), mobile industry processor interface (MIPI®), a multi-lane serial interface, and the like. In some embodiments, the transitory storage device 404 receives the plurality of images from the imaging device 104 via a multi-lane serial interface at a data rate of at least 20 Gbits/sec.

The plurality of images may be transferred from the transitory storage device 404 to the graphics unit 408 over bus 406. The total image data (e.g., 2048 images) may be transferred from the transitory storage device 404 to the graphics unit 408 via the bus 406.

Graphics unit 408 may be a component of the controller 301 that executes various image processing tasks on the plurality of images. In some cases, operations performed by the graphics unit 408 may be performed by the processor 304 in response to executing instructions stored in the memory 310. In some embodiments, the graphics unit may execute a task based on various characteristics. The characteristic may include a feature of the image relating to a material channel. Characteristics may include any feature of the image relating to a measured or detected response to the various light sources as captured within the image (e.g., brightness, intensity, reflectance). In some embodiments, the graphics unit 408 may analyze characteristics of each image in order to group the plurality of processed images into subsets based on the analyzed category. In some embodiments, the graphics unit 408 takes into account illumination setting associated with the captured images.

Image processing tasks executed by the graphics unit 408 include any task, process, technique, or procedure relating to PBR processing. For example, image processing tasks includes at least one of a high dynamic range (HDR) processing, signal-to-noise (S/N) enhancement, varied polarization elliptical state images capture, pixel shift registration, time delay integration (TDI), color correction, de-mosaicking, other custom (ISV) image manipulations. In some embodiments, the graphics unit 408 executes an image processing task (or a plurality of image processing tasks) on the plurality of images to obtain a plurality of processed images defining material channel data. As used herein, material channel data refers to a specific property or aspect of a material. Each material channel may correspond to a different attribute corresponding to how the material interacts with light and other elements in a three-dimensional environment. Material channels can include: base color/albedo, normal, height, roughness, metalness, roughness, ambient occlusion, and opacity. Base color/albedo may refer to base color information of the material without any lighting effects. Normal material channel data may refer to a normal map data, which characterizes how light interacts with the surface of the material (e.g., depth and detail). Height refers to displacement information and may enhance the surface details. Roughness measures the smoothness or roughness of the material surface, which informs the shine or matte-ness of the material. Metalness may define the metallic properties of the material and may distinguish between metal and non-metal surfaces. In other words, metalness may indicate how metallic a material is. Similarly, roughness may indicate how rough a material is. Ambient occlusion can refer to the occlusion of ambient light in crevices and corners which may add to the realism of the virtualized surface by enhancing shadows. Opacity refers to the transparency of the material. In some embodiments, the plurality of processed images defines a set of material channel data for the material, which may include some or all of the material channels described above.

To obtain processed images that define material channel data, the graphics unit 408 may execute at least one image processing task on the plurality of images. In addition, the graphics unit 408 may reduce the number of images into a representative or sampled set of processed images. This process may allow the transfer of a reduced set of images to a secondary electronic device or workstation and may reduce the computational cost of transferring the total amount of unprocessed images. In some embodiments, the graphics unit 408 analyzes a characteristic of each image of the plurality of images. The characteristic may include a feature of the image relating to a material channel. Characteristics may include any feature of the image relating to a measured or detected response to the various light sources as captured within the image (e.g., brightness, intensity, reflectance). In some embodiments, the graphics unit 408 may analyze characteristics of each image in order to group the plurality of processed images into subsets based on the analyzed category. For example, to define a particular material channel, the imaging device 104 may have captured a certain number of images relating to that material channel (e.g., to adequately capture the height, the imaging device 104 needs to capture X number of images to show a range of shadows). Each group or subset of images may refer to a particular material channel.

In some embodiments, the image processing task utilizes a specific characteristic from an image. For example, in some embodiments, the image processing task utilizes a specific characteristic from multiple images. For example, pixel alignment processing tasks, HDR processing, etc. may utilize multiple images (e.g., for each light source). In another example, albeto processing can utilize multiple polarization images at different elliptical viewing states. In some embodiments, the executed image processing task is based on the illumination settings. For example, multiple orientations of the lamps (e.g., eight lamps) may provide information to the images captured for photometric stereo (e.g., BDRF). Information from illumination settings (e.g., polarization of the lamps, brightness of the lamps, exposure settings) can be used to inform the type of image processing task executed on the captured images.

In some embodiments, the graphics unit 408 combines each image of the subset to obtain a combined or consolidated image. Combining or consolidation of the images in a group may include transforming, averaging, or selecting a representative image within the subset. This process may reduce the total number of processed images from the original number of captured images (e.g., 2048) to a reduced number (e.g., 64). As such, the output of the processes executed by the graphics unit 408 includes a subset of processed images. The subset of processed images may represent a sampled size of the plurality of images that have been rendered and processed by the various image processing tasks. The consolidation of images in a group allows for reducing the number of images to be transmitted to a downstream device, thereby providing savings (e.g., transfer time, computational resources) in a post-processing operation.

Processed images and/or the subset of processed images may be stored in the solid state device (SSD) 412. In some embodiments, the total image data (e.g., 2048 images) are stored in the SSD 412. In addition, or alternatively, the subset of processed images (e.g., 64 images) are stored in the SSD 412. The subset of processed images (and/or the total image data) may be transferred from the graphics unit 408 to the SSD 412 over connection 410. Connection 410 may include a peripheral component interconnect express (“PCIE”) or any other data transfer bridge between electronic components.

Processed images (e.g., reduced set of 64 images) may be transferred from the photometric imaging system 300 to a secondary electronic device (e.g., a server, a workstation, host computer). As shown in FIG. 4, connection bridge 416 (connected to the SSD 412 via the connection 414, wherein connection 414 may include any data transfer bridge between electronic components) may connect the controller 301 of the photometric imaging system 300 to a user device 420 (e.g., secondary electronic device). In some embodiments, connection bridge 416 is a universal serial bus (USB) connection. Connection bridge 416 can transfer the subset of processed images (e.g., 64 images) from the photometric imaging system 300 to the user device 420. The subset of processed images may be edited or processed separately by a user of the user device 420.

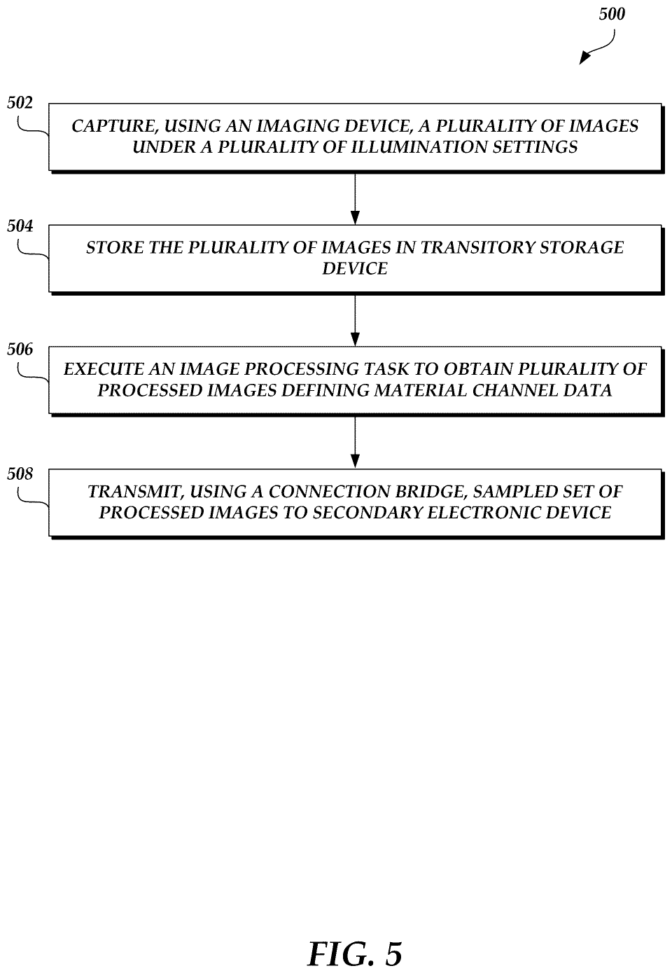

FIG. 5 is an example routine 500 for local pre-processing of photometric images for transfer to a secondary electronic device. Specifically, the routine 500 may be executed by the various components of the photometric imaging system 300, such as via the controller 301, shown in FIG. 3 and FIG. 4.

At block 502, a plurality of images are captured by the imaging device 104 under illumination settings. Illumination settings can include any setting relating to the capture of an image illuminated by the lamp 100 or within the photometric imaging system 300. For example, illumination settings can include at least one of a light orientation setting, a brightness level, a polarizer viewing state, and the like. In some embodiments, at block 502, the imaging device 104 captures the plurality of images using illumination settings associated with a photometric capture process such as photometric stereo capture or spatially varying bidirectional reflectance distribution function (SVBRDF) capture. In some embodiments, at block 502, the imaging device 104 capture a plurality of images (e.g., 2048 images). As described herein, photometric stereo capture systems, such as the photometric imaging system 300, may capture a plurality of images under various lighting conditions (e.g., by illuminating a sample from different relative locations) to visualize the appearance of a material surface.

At block 504, the plurality of images are stored in a transitory storage device 404. Transitory storage device 404 may include any transitory or volatile data store, such as random access memory (RAM), dynamic random access memory (DRAM), and the like. Transitory storage device 404 may be a portion of the memory 310 reserved for storage of the plurality of images captured by the imaging device 104. In some embodiments, the transitory storage device 404 receives the plurality of images from the imaging device 104 via a serial interface 402. Serial interface 402 includes any high-speed interface between a host processor and display module, such as a display serial interface (DSI), mobile industry processor interface (MIPI®), and the like.

At block 506, an image processing task is executed on the plurality of images to obtain a plurality of processed images. In some embodiments, the image processing task is executed by the graphics unit 408 on the plurality of images. As noted herein, the image processing tasks includes at least one of a high dynamic range (HDR) processing, signal-to-noise (S/N) enhancement, varied polarization elliptical state images capture, pixel shift registration, time delay integration (TDI), color correction, de-mosaicking, other custom (ISV) image manipulations. In some embodiments, at block 506, the graphics unit 408 executes an image processing task (or a plurality of image processing tasks) on the plurality of images to obtain a plurality of processed images defining material channel data. Material channel data may refer to a specific property or aspect of a material. Each material channel may correspond to a different attribute corresponding to how the material interacts with light and other elements in a three-dimensional environment. Material channels can include: base color/albedo, normal, height, roughness, metalness, ambient occlusion, and opacity.

In some embodiments, the graphics unit 408 executes a first image processing task on the plurality of images to obtain a plurality of processed images comprising material channel data while the imaging device 104 captures a second plurality of images. The second plurality of images may correspond to a subset of the total image data (e.g., a subset of the 2048 total images).

In some embodiments, at block 506, a characteristic of each image of the plurality of processed images is determined and subsets of the plurality of images are combined based on the determined characteristics to obtain a sampled set of processed images. The characteristic may include a feature of the image relating to a material channel. Characteristics may include any feature of the image relating to a measured or detected response to the various light sources as captured within the image (e.g., brightness, intensity, reflectance). In some embodiments, the graphics unit 408 may analyze characteristics of each image in order to group the plurality of processed images into subsets based on the analyzed category.

The feature or characteristic analyzed by the graphics unit 408 may change depending on which material channel data/feature is being determined. For example, in the case when roughness material channel data is being calculated, the graphics unit 408 may analyze an intensity pattern characteristic of the image(s). In this case, the graphics unit 408 may estimate a surface normal at each pixel of an image (which may describe how the surface tilts in a three-dimensional space). The resulting material channel data may correspond to a roughness map.

In another example, in the case when albedo material channel data is being calculated, the graphics unit 408 may analyze a brightness characteristic of each pixel. In this case, the albedo distribution is determined by the graphics unit 408 by analyzing the brightness of each pixel of an image(s) after accounting for the effects of surface orientation and lighting direction. The graphics unit 408 may isolate the albedo at each pixel by dividing the observed brightness by the cosine of the angle between the light source direction and the surface normal. This process may separate the intrinsic reflectance properties of the surface (albedo) from the shading effects caused by the surface geometry. The resulting albedo map can represent the spatial distribution of reflectance across the surface to show how different areas reflect light independent of lighting and surface shape.

In another example, in the case when metalness (or metallic property) material channel data is being calculated, the graphics unit 408 may analyze a reflectance characteristic in order to analyze how a surface reflects light. By examining the intensity and type of reflections across images, the graphics unit 408 may determine a degree of reflectance at each point on the surface. A higher specular reflection component may suggest a more metallic surface, while more diffuse reflection may indicate non-metallic (dielectric) material. In response to the analysis, the graphics unit 408 may generate a metalness map that indicates the metalness or metallic properties of different parts of the surface.

In some embodiments, the plurality of processed images are grouped into subsets based on the characteristic of each image. In some embodiments, the graphics unit 408 may analyze characteristics of each image in order to group the plurality of processed images into subsets based on the analyzed category. For example, to define a particular material channel, the imaging device 104 may capture a certain number of images relating to that material channel (e.g., to adequately capture the metalness material channel data, the imaging device 104 may need to capture X number of images to show the variance of light reflectance). Each group or subset of images may refer to a particular material channel. Based on the type of images taken, the plurality of processed images may be grouped into subsets or categories of images.

Combining or consolidation of the images in a group may include transforming, averaging, or selecting a representative image within the subset. This process may reduce the total number of processed images from the original number of captured images (e.g., 2048) to a reduced number (e.g., 64). As such, the output of the processes executed by the graphics unit 408 includes a subset of processed images. The subset of processed images may represent a sampled size of the plurality of images that have been rendered and processed by the various image processing tasks. In some embodiments, the controller 301 of the photometric imaging system 300 includes a flash memory to store the set of processed images, such as SSD 412. In some embodiments, the total image data (e.g., 2048 images) are stored in the SSD 412. In addition, or alternatively, the subset of processed images (e.g., 64 images) are stored in the SSD 412. The subset of processed images (and/or the total image data) may be transferred from the graphics unit 408 to the SSD 412 over connection 410. Connection 410 may include a peripheral component interconnect express (“PCIE”) or any other data transfer bridge between electronic components.

At block 508, the sampled set of processed images is transmitted, using a connection bridge, to a secondary electronic device, such as a server, workstation, host computer, etc. Connection bridge 416 (connected to the SSD 412 via the connection 414, wherein connection 414 may include any data transfer bridge between electronic components) may connect the controller 301 of the photometric imaging system 300 to a user device 420 (e.g., secondary electronic device). In some embodiments, connection bridge 416 is a universal serial bus (USB) connection. Connection bridge 416 can transfer the subset of processed images (e.g., 64 images) from the photometric imaging system 300 to the user device 420. The subset of processed images may be edited or processed separately by a user of the user device 420.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A photometric stereo image processing system comprising:
an imaging device to capture a plurality of images under a plurality of different illumination settings;
a transitory storage device to store the plurality of images from the imaging device;
a graphics unit to:
execute an image processing task on the plurality of images to obtain a plurality of processed images defining material channel data,
wherein the execution of the image processing task is based on a characteristic of the plurality of images; and
a connection bridge to transmit the plurality of processed images to a secondary electronic device.

2. The photometric stereo image processing system of claim 1, wherein the characteristic of the plurality of images is at least one of a shadow placement, intensity, brightness, or reflectance.

3. The photometric stereo image processing system of claim 1, wherein the plurality of different illumination settings includes light orientation settings, and polarizer viewing states.

4. The photometric stereo image processing system of claim 1, wherein the transitory storage device receives the plurality of images from the imaging device via a multi-lane serial interface at a data rate of at least 20 Gbits/sec.

5. The photometric stereo image processing system of claim 1, wherein the photometric stereo image processing system further includes a flash memory to store the plurality of processed images.

6. The photometric stereo image processing system of claim 1, wherein the image processing task includes at least one of high dynamic range (HDR) processing, signal-to-noise (S/N) enhancement, varied polarization elliptical state images capture, pixel shift registration, time delay integration (TDI), color correction, de-mosaicking, other custom (ISV) image manipulations.

7. The photometric stereo image processing system of claim 1, wherein the graphics unit is to execute the image processing task on the plurality of images to obtain the plurality of processed images defining the material channel data while the imaging device captures a second plurality of images.

8. The photometric stereo image processing system of claim 1, wherein the material channel data includes at least one of: base color/albedo, normal, height, roughness, metalness, ambient occlusion, or opacity.

9. The photometric stereo image processing system of claim 1, wherein the executed image processing task is based on the characteristic of the plurality of images and the plurality of different illumination settings.

10. The photometric stereo image processing system of claim 1, wherein the secondary electronic device includes a server, a workstation, or a host computer.

11. An imaging apparatus comprising:
an imaging device to capture a plurality of images under a plurality of illumination settings;
an embedded graphics unit, comprising:
a random access memory (RAM) to store the plurality of images from the imaging device;
a graphics unit to execute an image processing task on the plurality of images to obtain a plurality of processed images defining material channel data, wherein execution of the image processing task comprises:
determining, within a subset of the plurality of processed images, a characteristic of each image of the subset of the plurality of processed images, and
combining, based on the determined characteristic of each image, the images of the subset into a single processed image to obtain a sampled set of processed images; and
a connection bridge to transmit the sampled set of processed images to a secondary electronic device.

12. The imaging apparatus of claim 11, wherein the embedded graphics unit receives the plurality of images from the imaging device via a multi-lane serial interface.

13. The imaging apparatus of claim 11, wherein the plurality of illumination settings comprises illuminating a sample from different light directions using a light source.

14. The imaging apparatus of claim 11, wherein the imaging apparatus further includes a flash memory to store the sampled set of processed images.

15. The imaging apparatus of claim 11, wherein the image processing task includes at least one of high dynamic range (HDR) processing, signal-to-noise (S/N) enhancement, varied polarization elliptical state images capture, pixel shift registration, time delay integration (TDI), color correction, de-mosaicking, other custom (ISV) image manipulations.

16. The imaging apparatus of claim 11, wherein the imaging device is to capture the plurality of images under a plurality of illumination settings and a second plurality of images under the plurality of illumination settings, wherein the graphics unit is to execute the image processing task on the plurality of images to obtain the plurality of processed images defining material channel data while the imaging device is capturing the second plurality of images.

17. The imaging apparatus of claim 11, wherein the imaging device captures the plurality of images using illumination settings associated with a photometric capture process, the photometric capture process includes photometric stereo capture or spatially varying bidirectional reflectance distribution function (SVBRDF) capture.

18. A method, comprising:
capturing, using an imaging device, a plurality of images under a plurality of illumination settings;
storing the plurality of images in a transitory storage device;
executing an image processing task on the plurality of images to obtain a plurality of processed images defining material channel data, wherein executing the image processing task comprises:
determining a characteristic of each image of the plurality of images, and
combining subsets of the plurality of images to obtain a sampled set of processed images based on the determined characteristics; and
transmitting, using a connection bridge, the sampled set of processed images to a secondary electronic device.

19. The method of claim 18, wherein the method executing the image processing task further comprises grouping images of the plurality of images into subsets based on the characteristic of each image of the plurality of images.

20. The method of claim 18, wherein the image processing task includes at least one of high dynamic range (HDR) processing, signal-to-noise (S/N) enhancement, varied polarization elliptical state images capture, or pixel shift registration.

21. The method of claim 18, wherein capturing the plurality of images under the plurality of illumination settings comprises illuminating a sample using a light source from different relative positions and providing a polarizer view state using a polarizer positioned in between the imaging device.
